(19) United States
(12) Patent Application Publication
(10) Pub. No.: US 2021/0331893 A1
(43) Pub. Date: Oct. 28, 2021

(54) FIRE PROTECTION DEVICE FOR AN ELEVATOR SYSTEM

(71) Applicant: thyssenkrupp Elevator Innovation and Operations AG, Essen (DE)

(72) Inventors: Richard THUM, Kornwestheim (US); Eduard STEINHAUER, Nürtingen (DE)

(73) Assignee: thyssenkrupp Elevator Innovation and Operations AG, Essen (DE)

(21) Appl. No.: 17/250,368

(22) PCT Filed: Jul. 12, 2019
(86) PCT No.: PCT/EP2019/068828

§ 371 Date: Jun. 8, 2021

(30) Foreign Application Priority Data
Jul. 13, 2018 (DE) 10 2018 211 733.0

(51) Int. Cl. B66B 5/02; B66B 9/00; B66B 11/00; E04F 17/00

(52) U.S. Cl. CPC B66B 5/024; E04F 17/005; B66B 11/0005; B66B 9/003

(57) ABSTRACT

An elevator system with a fire protection device includes an elevator shaft having at least two adjacent shaft portions, a guide rail in the elevator shaft, a car displaceable on the guide rail, and a fire protection device having a detector, a control unit connected to the detector, and a closing element that is disposed between two mutually adjacent shaft portions of the elevator shaft and which is movable between an open and closed state to separate the two shaft portions while in the closed state. A method of operating a fire protection device for an elevator system includes detecting smoke and/or a fire via a detector, and transferring a closing element disposed in the elevator shaft from an opened state to a closed state.

The invention relates to a fire protection device for an elevator system, wherein the elevator system comprises at least one elevator shaft in which at least one car is displaceable along at least one guide rail.

The invention furthermore relates to a method for operating such a fire protection device.

The invention furthermore relates to an elevator system comprising such a fire protection device or comprising a control unit which is configured for carrying out such a method for operating such a fire protection device.

DIN EN 81-72:2015 contains the standards in terms of safety technology for a fireman's elevator. According to DIN EN 81-72:2015, a “safe region” or a fire protection hatch/fire protection door has to be present in front of each shaft door of a fireman's elevator shaft. A safe region herein refers to a region which is equipped with a safe path to the elevator and a safe exit, for example by way of stairs, and which on account of suitable fire-resistant installations is shielded from the fire and kept free of smoke. The fire-resistant installations herein are bulkheads or fire protection doors by means of which the safe region is separated from the remainder of the building.

A safe region for a fireman's elevator has to be situated in front of each shaft door which is used during the fireman's operation. Furthermore, shaft doors which are not provided for use by the fire brigade and do not have any safe region have to be protected by fire protection hatches or fire protection doors.

According to DIN EN 81-72:2015, the shaft is accordingly separated from the building by means of fire protection doors and/or fire-resistant bulkheads. The shaft herein is indirectly separated from the building in that a safe region that is situated in front of a shaft door is separated from the building by means of fire protection doors and/or bulkheads, or the shaft is directly separated from the building when a shaft door is protected by fire protection doors.

If smoke and/or a fire is present in an elevator shaft, the shaft according to DIN EN 81-72:2015 is separated from the building by means of fire protection doors and thus forms a single vertical fire portion.

In the fire protection device known from the prior art for an elevator system it is problematic that, in the event of fire in an elevator shaft, smoke and/or the fire propagates within the elevator shaft. While this propagation is indeed counteracted by means of venting smoke, for example by means of pressurized ventilation, the latter is effective only to a limited extent by virtue of the stack-effect prevalent in an elevator shaft. The elevator shaft can only be used as a fireman's elevator, wherein the firemen wear protective clothing which protects them against burns and smoke inhalation. It is typically not possible for the elevator system to continue to operate for clearing the building, so that people to be evacuated have to leave the building by way of stairs, wherein people with restricted mobility often have to be carried.

A particularly problematic situation presents itself when the elevator system comprises a plurality of elevator shafts that are connected to one another. In this case, smoke and/or a fire can propagate from one elevator shaft to another elevator shaft and in this way propagate into many parts of the building. In order for this to be at least partially abated, a pressurized ventilation would have to be maintained simultaneously in all interconnected elevator shafts, this being associated with a high level of technical complexity.

Against this background, it is an object of the present invention to improve a fire protection device mentioned at the outset for an elevator system, as well as to provide an improved method for operating a fire protection device, as well as an elevator system comprising such a fire protection device, or comprising a control unit which is configured for carrying out such a method for operating such a fire protection device. A propagation of smoke and/or a fire within an elevator shaft, in particular a propagation in further elevator shafts of the elevator system that are connected to this elevator shaft, is in particular to be prevented here. Furthermore, the use of such an elevator shaft in the presence of smoke and/or of fire in an elevator shaft is in particular to be improved.

A fire protection device for an elevator system, a method for operating a fire protection device for an elevator system, as well as an elevator system according to the independent claims are proposed for achieving this object. Further advantageous design embodiments of the invention are described in the dependent claims and the description as well as illustrated in the exemplary embodiment shown in the figures.

The proposed solution provides a fire protection device for an elevator system, wherein the elevator system comprises at least one elevator shaft in which at least one car is displaceable along at least one guide rail.

It is in particular provided that the fire protection device comprises at least one closing element, wherein the closing element is disposed in the elevator shaft and is able to be transferred between an opened state and a closed state. The closing element is in particular configured as a smoke protection curtain or as a smoke screen. The closing element is in particular configured as a fire protection door or as a fire protection roller shutter. The closing element comprises in particular at least one door leaf and/or at least one roller shutter and/or at least one folding shutter. The closing element comprises in particular a static bulkhead.

In one design embodiment, the fire protection device for the elevator system comprises a control unit and at least one detector.

The elevator shaft of the elevator system in which the closing element is disposed has at least two shaft portions. The closing element is in particular disposed between two mutually adjacent shaft portions of the elevator shaft such that the closing element, when the latter is situated in the closed state, at least partially, in particular completely, mutually separates the two mutually adjacent shaft portions.

The closing element, when the latter is situated in the closed state, in particular mutually separates the two mutually adjacent shaft portions in such a manner that a propagation of smoke and/or of a fire from a first shaft portion to a second shaft portion adjacent thereto is suppressed.

In one design embodiment, the at least one detector of the fire protection device is disposed in at least one of the shaft portions of the elevator shaft and/or on the car that is displaceable in the elevator shaft. The detector disposed on the car is in particular disposed in the interior of the car.

The detector of the fire protection device is in particular specified for detecting smoke and/or a fire. The detector herein comprises in particular a smoke alarm and/or an infrared detector. The detector is in particular specified for detecting a temperature differential.

In one design embodiment, the control unit of the fire protection device is configured to transfer the closing element between the opened state and the closed state as a function of a signal emitted by the detector.

In particular, the closing element in a normal operation of the elevator system is situated in the opened state. The detector, when the latter detects smoke and/or a fire, in particular transmits a signal to the control unit. The control unit thereupon in particular transfers the closing element to the closed state so that the at least one shaft portion in which the smoke and/or the fire has been detected is at least partially, in particular completely, separated from the at least one shaft portion that is adjacent to this shaft portion.

Shaft elements, in particular shaft elements that run vertically in the elevator shaft, are typically present in elevator shafts. These shaft elements that run vertically in the elevator shaft herein are in particular guide rails which protrude into the interior space of the elevator shaft. Furthermore, in elevator systems with rope guide, at least one suspension rope of the car, which may also be configured as a suspension belt, and optionally a compensation rope which can also be configured as a compensation chain, extend in particular in the vertical direction in the elevator shaft.

In one design embodiment, at least one of the closing elements has clearances for passing through at least one vertically running shaft element, in particular at least one guide rail and/or at least one rope, wherein the rope can be embodied as a suspension rope or as a compensation rope, so as to enable the closing elements that are disposed in an elevator shaft to be completely closed.

The clearances in the closing elements are in particular disposed in at least one closing element segment of the closing element. The clearances are in particular disposed on at least one edge of the at least one closing element segment. The at least one closing element segment is in particular a door leaf and/or a roller shutter and/or a folding shutter.

The clearances for the guide rails are in particular adapted to the design embodiment of the guide rails. In this way, the spacing between the at least one closing element segment of the closing element and the guide rails is minimized in the closed state of the closing element.

The leakage location of the closing element that is present on account of the spacing between the at least one closed closing element segment of the closing element and the at least one guide rail is closed by means of a sealing material, in particular a deformable sealing material. A passage of smoke or a propagation of a fire from one shaft portion to another shaft portion is thus avoided. The deformable sealing material is in particular a fire protection foam and/or a rubber lip and/or a brush seal.

In elevator systems with a rope guide, the rope guide requires a particular construction of the closing element that is disposed in the elevator shaft, in particular when the closing element is a fire protection door or a fire protection roller shutter, so that the rope is not damaged when the closing element is transferred from an opened state to a closed state. In particular, the closing element in an elevator system in which a car is connected to a counterweight by way of a suspension rope and/or a compensation rope so as to avoid any damage to the rope guide is divided into two closing element sectors. A first closing element sector is in particular assigned to a region of the elevator shaft in which the car is displaced, and a second closing element sector is assigned to a region of the elevator shaft in which the counterweight is displaced. In particular, each of the two closing element sectors here has two closing element segments, respectively. The closing element segments are in particular configured in such a manner that the position of the suspension rope or of the compensation rope, respectively, in the projection plane of the elevator shaft is not substantially varied by closing the closing element segments.

In particular, a first closing element segment of the first closing element sector and/or of the second closing element sector on at least one edge has clearances for passing through at least one rope. In particular, a second closing element segment of the first closing element sector and/or of the second closing element sector on at least one edge has clearances for passing through at least one rope.

A plurality of clearances for the rope guide are in particular disposed beside one another on the at least one edge of the first and/or second closing element segment of the first and/or second closing element sector such that this results in a comb pattern.

The first closing element segment of the first closing element sector and/or of the second closing element sector has the clearances in particular on that edge that faces the edge of a second closing element segment of the first closing element sector and/or of the second closing element sector when the closing element is situated in the closed state.

The second closing element segment of the first and/or second closing element sector has the clearances in particular on that edge that faces the edge of the first closing element segment of the first and/or second closing element sector, when the closing element is situated in the closed state. Both closing element segments of the two closing element sectors have in particular in each case on at least one edge clearances for the suspension rope or the compensation rope, respectively. The clearances on the edge of the first closing element segment of the first and/or second closing element sector and the clearances on the edge of the second closing element segment of the first and/or second closing element sector are in particular disposed in such a manner that the clearances of the first closing element segment and the clearances of the second closing element segment lie opposite one another in the closed state of the closing element. The clearances of the first closing element segment and the clearances of the second closing element segment are in particular disposed in such a manner that in the closed state of the closing element a rope is guided through a clearance which is provided by a clearance of the first closing element segment and a respective opposite clearance of the second closing element segment.

In one advantageous design embodiment, the regions between the plurality of mutually adjacently disposed clearances for the rope guide on the edge of the closing element segment have in each case a tapered shape. On account of this tapered shape, the rope when transferring the closing element to the closed state is guided into one of the clearances.

By lining up a plurality of clearances beside one another it is guaranteed when transferring the closing element to the closed state that the rope is also guided into a clearance in the event of rope vibrations. It is prevented in this way that the rope is damaged by virtue of rope vibrations when transferring the closing element to the closed state. On account of the disposal of a plurality of clearances beside one another it is avoided on the other hand that the suspension rope or the compensation rope, respectively, by virtue of rope vibrations blocks the closing element from completely closing. The design embodiment of the clearances as a comb pattern furthermore has the effect that a spacing between the closing element segments in the closed state of the closing element is minimized.

In order to avoid any propagation of smoke and/or of a fire through the leakage locations in the closing element that are created on account of the clearances for the rope guide, said leakage locations are filled by means of a deformable sealing material. The sealing material is in particular a fire protection foam. Alternatively or additionally, the sealing material is in the form of rubber lips and/or a brush seal which are in each case disposed on the mutually abutting edges of the closing element segments of the closing element sectors.

Closing elements which have a first closing element sector and a second closing element sector can be embodied in various ways. The closing element segments of the first closing element sector and of the second closing element sector are in particular disposed in such a manner that said closing element segments in the closed state form a planar compact face which separates a first shaft portion from a second shaft portion. In particular, the first closing element sector is spaced apart from the second closing element sector by a platform which is at least partially fixedly disposed so as to be in particular horizontal in the elevator shaft. In particular, the first closing element sector and the second closing element sector are disposed so as to be mutually offset in the vertical direction of the elevator shaft. In particular, the first closing element sector and the second closing element sector are spaced apart by a platform that is disposed in the elevator shaft, wherein the platform at least partially extends in the vertical direction of the elevator shaft. The two closing element sectors in the closed state of the closing element, conjointly with the platform which is at least partially disposed in the vertical direction of the elevator shaft, form a stepped compact face which separates the first shaft portion from the second shaft portion.

In one further design embodiment of the invention, the fire protection device is configured for an elevator system which comprises at least one first elevator shaft and at least one second elevator shaft and at least one shaft switchover unit, the car being able to be switched from the first elevator shaft to the second elevator shaft by means of said shaft switchover unit. The first elevator shaft and/or the second elevator shaft herein has at least two shaft portions, wherein the closing element of the fire protection device is disposed between two mutually adjacent shaft portions of the first elevator shaft and/or of the second elevator shaft. In the closed state, the closing element at least partially, in particular completely, mutually separates the two mutually adjacent shaft portions of the first elevator shaft and/or of the second elevator shaft.

The elevator system herein comprises in particular a plurality of elevator shafts in which a plurality of cars are displaced individually, that is to say in a substantially mutually independent manner, by means of a linear motor drive. The elevator system comprises in particular vertically aligned elevator shafts in which the cars are vertically displaced along guide rails, as well as horizontally aligned elevator shafts in which the cars are horizontally displaced along guide rails. In particular, the travel direction of a car changes from the vertical over to the horizontal or vice versa by means of shaft switchover units. While using shaft switchover units, a car can in particular be switched from one elevator shaft over to a second elevator shaft.

The elevator system comprises in particular diagonally aligned elevator shafts in which the cars are obliquely displaced.

In particular, at least one vertical elevator shaft and/or at least one horizontal elevator shaft has at least two shaft portions, wherein one closing element is in each case disposed between two mutually adjacent shaft portions. It is possible herein that a shaft portion is adjacent to at least one shaft portion of a vertical elevator shaft as well as adjacent to at least one shaft portion of a horizontal elevator shaft. In order for such a shaft portion to be separated from all adjacent shaft portions, it is necessary for at least one closing element to be in each case transferred to the closed state in at least one vertical elevator shaft as well as in at least one horizontal elevator shaft.

No rope guide is present in an elevator system in which cars are displaced by means of a linear motor drive, this substantially simplifying a design embodiment of a closing element which is disposed in an elevator shaft of such an elevator system.

The closing element in such an elevator system can be embodied in different ways. The at least one closing element segment of the closing element is in particular configured as a pivotable door or as a sliding door. In particular, the at least one closing element segment of the closing element is configured as a deployable roller shutter or folding shutter.

Clearances for passing through at least one shaft element which is disposed in a direction perpendicular to the closing element are disposed in the at least one closing element segment of the closing element. The shaft element is in particular a guide rail.

The clearances are in particular disposed on at least one edge of the at least one closing element segment.

The closing element has in particular a single-part closing element segment, wherein the closing element segment is designed as a pivotable swing door, or a sliding door, or a roller shutter, or a folding shutter. In particular, the closing element segment on an edge has clearances for passing through a shaft element, in particular a guide rail.

The closing element segment of the closing element is in particular embodied in two parts, wherein the two-part closing element segment is configured as pivotable swing doors, or sliding doors, or roller shutters, or folding shutters. The two-part closing element segment of the closing element is in particular embodied in such a manner that the two parts of the closing element segment in a closed state of the closing element come together in a centric position of a shaft element, in particular of a guide rail.

The clearances are in particular adapted to the shape of the shaft element, in particular of the guide rail, such that a spacing between the at least one closing element segment from the shaft element is minimal in the closed state of the closing element.

Any leakage of the closing element that results from a spacing between the closing element segment of the closing element from the shaft element is in particular counteracted in that this spacing is filled by a deformable sealing material. The sealing material is in particular a fire protection foam.

In the closed state of the closing element an additional leakage of the closing element in a two-part or multi-part closing element segment of a closing element results at the location where the individual parts of the closing element segment come together. In order to counteract any propagation of smoke and/or of a fire through this leakage of the closing element, the closing element at these locations has a deformable sealing material. The sealing material is in particular a fire protection foam by way of which the closing element is sealed in the closed state. Alternatively or additionally, the sealing material is in the form of rubber lips and/or a brush seal.

In comparison to the multi-part embodiment of the closing element segment of the closing element, the embodiment of a single-part closing element segment offers the advantage that the closing element in the closed state does not have any joint which by virtue of the multi-part embodiment extends across the entire width of the closing element segment. In this way, fewer leakage locations which have to be sealed by means of a sealing material result in an embodiment having a single-part closing element segment.

The embodiment of a multi-part closing element segment however has the advantage that the individual parts of the closing element segment have in each case a lower mass than a closing element segment embodied in a single part. The lower mass simplifies transferring the closing element between an opened and a closed state.

In one embodiment, the fire protection device for an elevator system which comprises at least one first elevator shaft and at least one second elevator shaft and at least one shaft switchover unit, the car being able to be switched from the first elevator shaft to the second elevator shaft by means of said shaft switchover unit, comprises a closing element which is disposed on the shaft switchover unit.

The shaft switchover unit comprises in particular a stationary part and a movable part. In particular, the stationary part of the shaft switchover unit is fixedly disposed on a shaft wall in a crossover region of the first elevator shaft and of the second elevator shaft. The movable part is in particular disposed so as to be movable, in particular rotatable, on the stationary part. The travel direction of the car is in particular predefined by the orientation of the movable part.

The movable part of the shaft switchover unit is in particular configured as a movably, in particular as a rotatably, mounted rail element. In particular, the rail element is rotated for a shaft switchover of the car such that the travel direction of the car changes on account of the variation of the orientation of the rail element.

In one design embodiment the closing element is disposed on the movable part of the shaft switchover installation. The closing element comprises in particular at least one static fire-resistant bulkhead.

The at least one static bulkhead is in particular fixedly disposed on the movable part in such a manner that the closing element at all times closes at least one opening to the first elevator shaft or to the second elevator shaft, said opening being situated in a direction which deviates from the travel direction of the car, being in particular situated so as to be orthogonal to the travel direction of the car predefined by the orientation of the movable part.

The at least one static bulkhead is in particular configured so as to be arcuate. In this way, the movable part can be rotated without impediment on the stationary part. On account of the arcuate shape of the static bulkheads, an opening to the first elevator shaft or the second elevator shaft is furthermore completely closed, said opening being situated in a direction that deviates from the travel direction of the car.

One static bulkhead is in particular disposed in each case on both sides of the movable part. The static bulkheads are in particular disposed on the movable part in such a manner that the closing element is opened exclusively in the travel direction of the car.

Additionally to the at least one static bulkhead, the closing element can comprise at least one movable bulkhead which is disposed so as to be movable on the static bulkhead. The control unit of the fire protection device as a function of a signal emitted by the detector is in particular specified for transferring the at least one movable bulkhead between the opened state and the closed state.

In one design embodiment the at least one bulkhead is disposed on the static bulkhead in such a manner that the at least one movable bulkhead does not protrude beyond the area that is defined by the static bulkhead on which the at least one movable bulkhead is disposed.

Two movable bulkheads are in particular disposed in each case on one static bulkhead. The area that is defined by the static bulkhead on both sides of the static bulkhead is in particular enlarged by transferring the movable bulkheads to the closed state.

The area of a movable bulkhead corresponds in particular to at least half the area of the static bulkhead such that at least half a cross-sectional area of an elevator shaft can be covered by means of a movable bulkhead in the closed state.

In particular, the at least one movable bulkhead is, in normal operation, entrained by the static bulkhead on which the at least one movable bulkhead is disposed.

It is accomplished in this way that, in normal operation, a travel path for a car in the direction of orientation of the movable part of the shaft switchover unit is not blocked by a movable bulkhead.

The closing element comprises at least one drive for transferring the at least one movable bulkhead from an opened state to a closed state.

The at least one movable bulkhead by means of the control unit of the fire protection device is transferred from an opened state to a closed state in that the control unit actuates the at least one drive of the the associated movable bulkhead, said drive setting the movable bulkhead in motion.

When all movable bulkheads of a closing element are transferred to the closed state, the closing element thus completely encloses the shaft switchover unit. This has the advantage that a shaft switchover unit is protected in the case of fire and it is thus prevented that the complex technical equipment of the shaft switchover unit incurs no damage.

According to the invention, the method for operating an above-described fire protection device for an elevator system comprises detecting smoke and/or a fire, in particular by means of a detector. As a consequence of detecting smoke and/or a fire, a closing element which is disposed in an elevator shaft is transferred from an opened state to a closed state.

When a detector detects smoke and/or a fire, this detector transmits a signal to a control unit. The signal transmitted by the detector to the control unit contains an item of information pertaining to the location where the detector is disposed.

If the detector is disposed in an elevator shaft, the signal thus contains an item of information pertaining to the elevator shaft and the shaft portion of the at least two shaft portions of the elevator shaft in which the detector is disposed.

If the detector is disposed on a car, in particular in a car, the signal thus contains an item of information pertaining to the car on which the detector is disposed. The control unit contains in particular an item of information pertaining to the current position of the car, when the detector is disposed on the car. The control unit receives in particular an item of information pertaining to whether the car stops at a stop, or whether the car is displaced in a travel direction. The control unit receives in particular an item of information pertaining to the travel direction in which the car on which the detector is disposed is displaced.

If the detector which transmits the signal to the control unit is disposed on the car, and if the car at the point in time at which the detector transmits the signal to the control unit is displaced in a travel direction, the car thus approaches a predetermined, in particular a closest stop, which is situated in the travel direction of the car. In particular, the car is prevented from any onward travel at the predetermined stop approached by said car.

Each of the at least two shaft portions of the at least one elevator shaft advantageously has at least one stop, in particular at least one predetermined stop on a floor level of a building. The onward travel of the car on which that detector that transmits the signal to the control unit is disposed is minimized in this way. In particular, people who are situated in the car can be evacuated from the car at the stop that is approached by the car.

If the detector that transmits the signal to the control unit is disposed on the car and if the car at the point in time at which the detector transmits the signal to the control unit stops at a stop, the car is thus prevented from any onward travel at this stop.

If the detector that transmits the signal to the control unit is disposed on the car, the shaft portion in which that stop that the car has approached and/or at which the car is prevented from any onward travel is situated is assigned to an exclusion region.

If the detector that transmits the signal to the control unit is disposed in an elevator shaft, the shaft portion in which the detector is situated is assigned to an exclusion region.

It is possible herein that a plurality of shaft portions in one elevator system are assigned to a common exclusion region. It is likewise possible for a plurality of exclusion regions to be simultaneously present in one elevator system when smoke and/or a fire is detected in a plurality of shaft portions that are spatially spaced apart.

Ventilation openings of a car are in particular closed when smoke and/or a fire is detected in a shaft portion, so as to avoid any ingress of smoke into the car by way of the ventilation openings. The interior space of the car is in particular fed oxygen.

As soon as a shaft portion is assigned to an exclusion region it is checked whether a car and/or a counterweight is in transit through the exclusion region. In the case of being in transit, the respective car and/or the counterweight are/is displaced out of the exclusion region without stopping.

It is in particular prevented in this way that a car occupied by people is trapped in the exclusion region by closing elements being closed, on account of which the exclusion region is separated from the shaft portions that are adjacent to said exclusion region.

It is furthermore checked whether there is any risk of a car and/or of a counterweight colliding with the closing element as a result of a transfer of the closing element to the closed state.

If it is established that a car and/or a counterweight are/is displaced in a travel direction in the direction of the closing element that is to be transferred to the closed state, and if there is a risk of collision, the car and/or the counterweight thus transit/transits through the exclusion region without stopping. The closing element is transferred to the closed state only once there is no longer any risk of collision.

If it is established that a car and/or a counterweight is displaced in a travel direction in the direction of the closing element that is to be transferred to the closed state, and if the spacing of the car and/or of the counterweight from this closing element corresponds to a value between a first limit value and a second limit value, the car and/or the counterweight are/is thus decelerated.

The car and/or the counterweight are/is in particular decelerated when the car and/or the counterweight have/has at least a minimum spacing from the closing element which is to be transferred to the closed state. The required braking distance based on the current travelling speed of the car and/or of the counterweight is in particular determined herein. The minimum spacing must in particular correspond to at least a spacing which corresponds to the distance of the braking distance. The minimum spacing must in particular correspond to at least a spacing which corresponds to the sum of the distance of the braking distance and the width of the at least one closing element segment of the closing element.

When a car which has been displaced in a travel direction in the direction of the closing element that is to be transferred to the closed state is decelerated, this car is thus displaced to a stop that is situated outside the exclusion region. This stop is in particular a stop that is situated outside the exclusion region and is closest to the position of the decelerated car. People who are situated in the car are in particular enabled to exit the car at this stop. An evacuation path display is in particular electronically connected to the control unit of the elevator system. The evacuation path display indicates in particular the direction of the evacuation path.

If a car and/or a counterweight has transited through an exclusion region, the control unit revokes a free transit clearance for the car and/or for the counterweight through the shaft portion that is assigned to the exclusion region as soon as the transit of the car and/or of the counterweight is completed, such that the car and/or the counterweight has been displaced out of the exclusion region. The closing element is transferred to the closed state only once the transit of the car and/or of the counterweight has been completed, thus no car and/or counterweight is any longer in transit through the exclusion region.

If there was any risk of a car and/or of a counterweight colliding with the closing element that is to be transferred to the closed state, the control unit revokes a free transit clearance for the car and/or for the counterweight through the shaft portion that is assigned to the exclusion region as soon as the risk of the car and/or of the counterweight colliding with the closing element as a result of a transfer of the closing element to the closed state is precluded. The closing element is furthermore transferred to the closed state as soon as the risk of the car and/or of the counterweight colliding with the closing element as a result of a transfer of the closing element to the closed state is precluded.

A closing element is in particular transferred to the closed state only when a car and/or a counterweight that has been displaced in a travel direction in the direction of the closing element to be transferred to the closed state has been decelerated such that there is no risk of any collision when transferring the closing element to the closed state.

A vacuum is thus generated in the exclusion region if a closing element is situated in the closed state, and if an exclusion region is separated from the at least one shaft portion adjacent thereto, in particular separated from all adjacent shaft portions, in particular completely separated therefrom. A vacuum is in particular present in the exclusion region as soon as the air pressure in the exclusion region has a lower value than the air pressure in the at least one shaft portion that is adjacent to the exclusion region and is separated from the exclusion region by a closing element which is situated in the closed state. In particular, the at least one shaft portion that is adjacent to the exclusion region is insulated in an air-tight manner by the closing element disposed between this shaft portion and the exclusion region.

A vacuum in the exclusion the region is in particular present as soon as the air pressure in the exclusion region has a lower value than the air pressure in the at least one safe region outside the elevator shaft that can be used for evacuation purposes. The safe region is in particular separated from the exclusion region by a closed shaft door. The safe region is in particular separated from the exclusion region by a closed closing element.

The vacuum generated in the exclusion region has the effect that smoke generated does not exit from the exclusion region into adjacent shaft portions and/or into safe regions outside the elevator shaft.

Alternatively or additionally to the vacuum in the exclusion region, a pressurized ventilation is activated in the at least one shaft portion that is adjacent to the exclusion region. A pressurized ventilation is in particular activated in the at least one safe region that is adjacent to the exclusion region. A propagation of smoke is counteracted by a pressurized ventilation.

On account of the disposal of closing elements in the elevator shaft and the separation of an exclusion region from the shaft portions adjacent thereto as a result of the transfer of closing elements to the closed state it is possible that the smoke and/or fire detected in the exclusion region is kept in the separated exclusion region away from all other shaft portions of the elevator system. It can thus be accomplished that the elevator system outside the exclusion region is not compromised by smoke and/or the fire.

This thus results in the possibility that a car is displaced in normal operation outside of the exclusion region when the at least one closing element is situated in the closed state such that the exclusion region is separated.

When a car has been decelerated and displaced to a stop that is situated outside the exclusion region, an evacuation path display in particular directs people exiting this car to a stop of the elevator system where onward travel using a car in normal operation is possible. The stop where the onward travel is possible is in particular situated on the same building level as the stop, at which the decelerated car has been stopped. People who have exited the decelerated car are in particular guided by way of a staircase to another building level where onward travel is possible by means of the evacuation path display. A traffic volume in terms of people is in particular taken into account herein. In the case of a high traffic volume in terms of people, when a plurality of cars have been decelerated, people from a first decelerated car are in particular directed via a different evacuation path by means of the evacuation display than people from a second decelerated car.

Apart from the possibility of being able to operate an elevator system in normal operation outside an exclusion region, risks to firemen during a fire brigade deployment are reduced on account of the fire protection device according to the invention.

Further advantageous details, features and design embodiment details of the invention will be explained in more detail in conjunction with the exemplary embodiments illustrated in the figures in which:

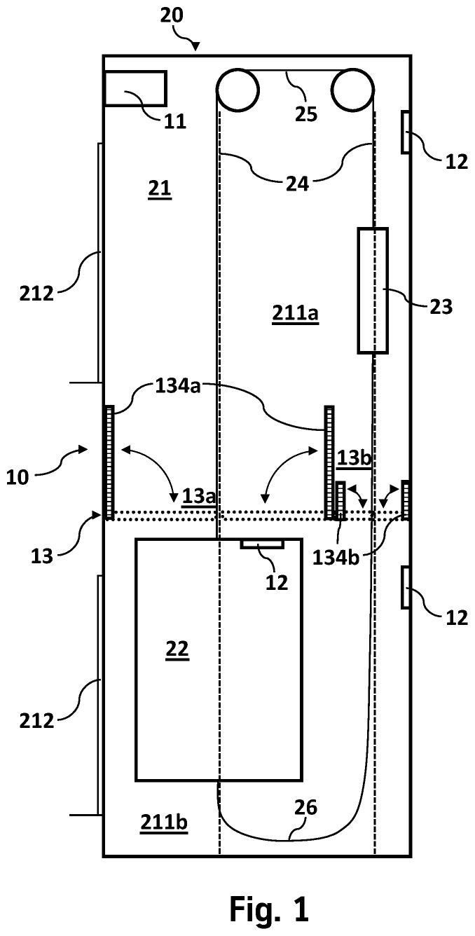

FIG. 1 in a simplified schematic illustration shows an exemplary embodiment for a fire protection device according to the invention for an elevator system;

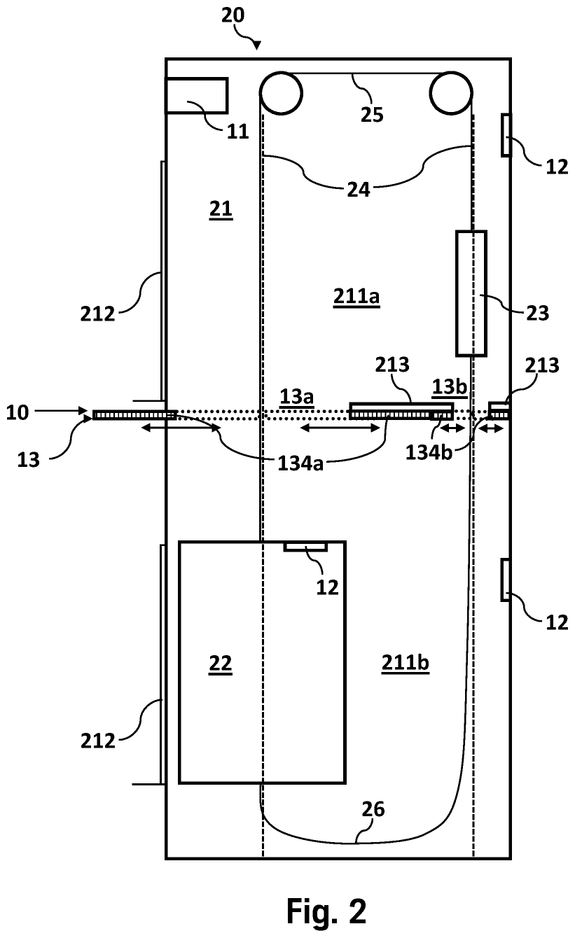

FIG. 2 in a simplified schematic illustration shows a further exemplary embodiment for the design embodiment of a fire protection device according to the invention for an elevator system;

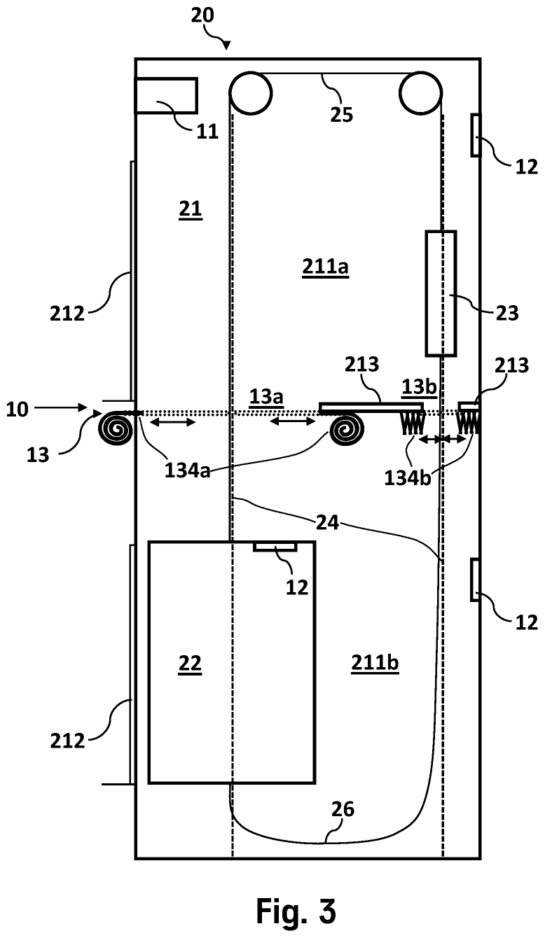

FIG. 3 in a simplified schematic illustration shows a further exemplary embodiment for the design embodiment of a fire protection device according to the invention for an elevator system;

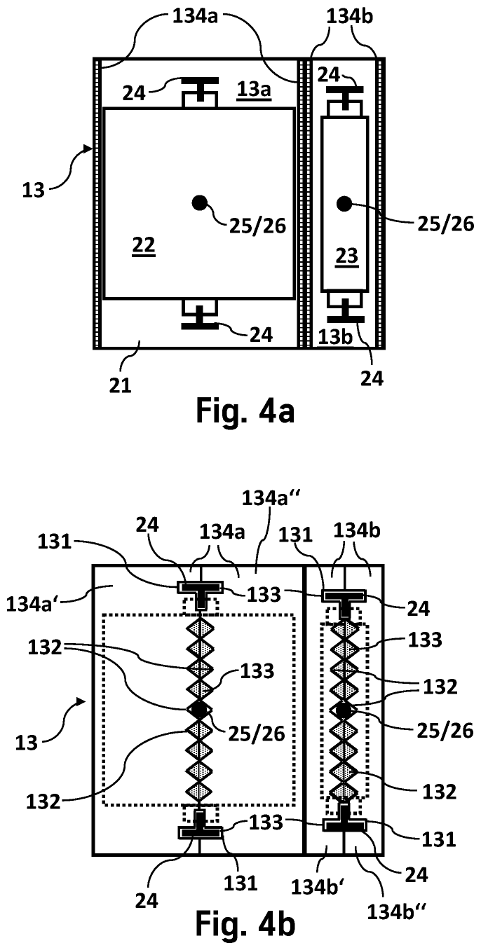

FIG. 4a in a simplified schematic illustration and a plan view shows the closing element in an opened state in an elevator system according to one of the exemplary embodiments illustrated in FIG. 1, FIG. 2, or FIG. 3;

FIG. 4b in a simplified schematic illustration and a plan view shows the closing element in a closed state in an elevator system according to one of the exemplary embodiments illustrated in FIG. 1, FIG. 2, or FIG. 3;

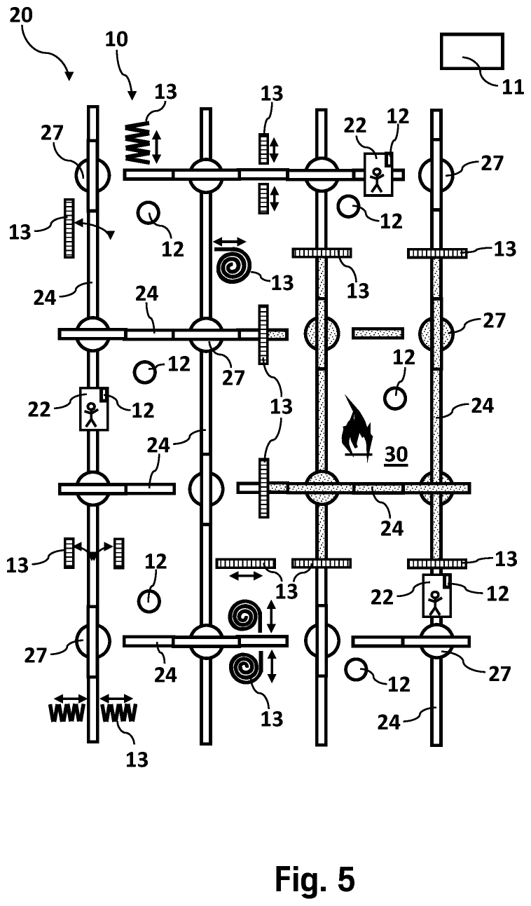

FIG. 5 in a simplified schematic illustration shows a further exemplary embodiment for the design embodiment of a fire protection device according to the invention in an elevator system;

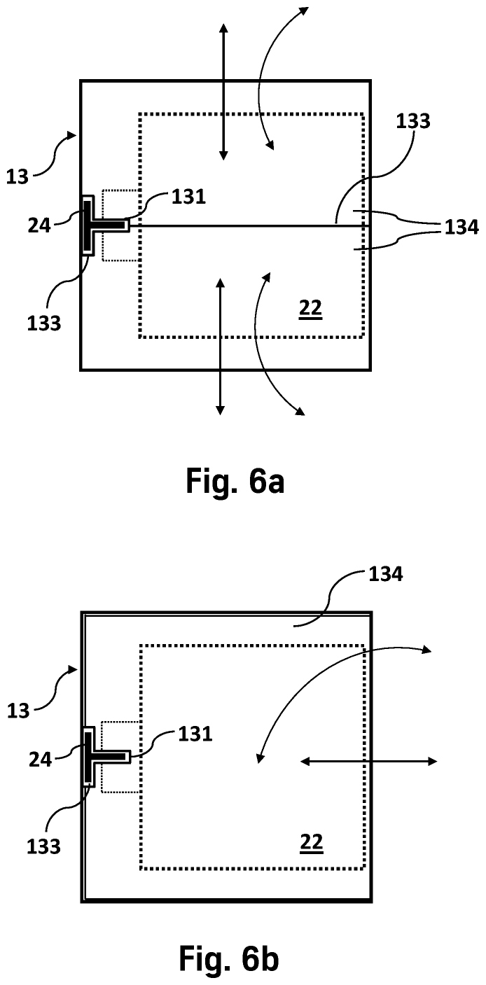

FIG. 6a in a simplified schematic illustration and a plan view shows an exemplary embodiment for the design embodiment of the closing element in an elevator system according to FIG. 5;

FIG. 6b in a simplified schematic illustration and a plan view shows a further exemplary embodiment for the design embodiment of the closing element in an elevator system according to FIG. 5;

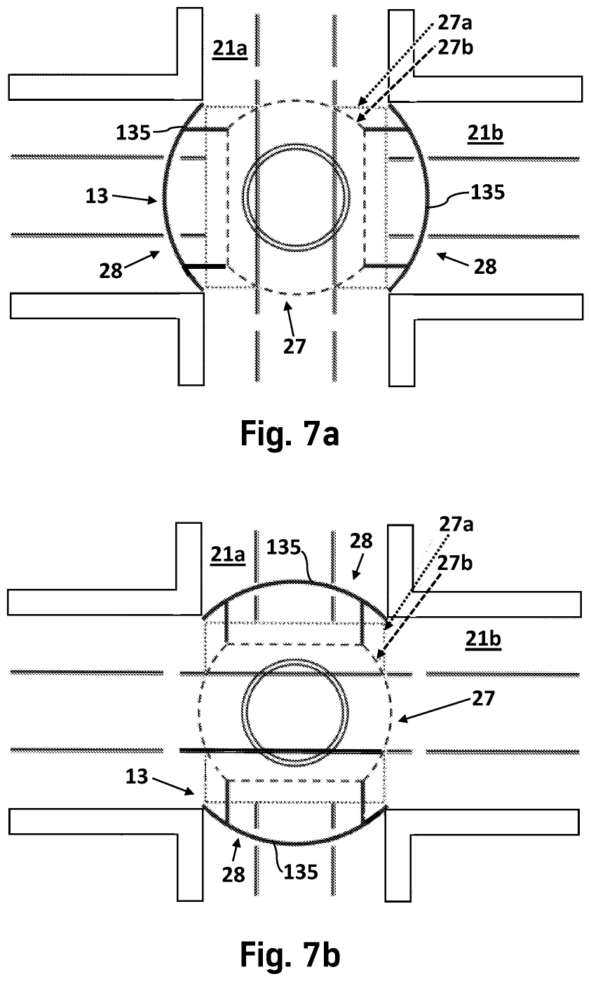

FIG. 7a in a simplified schematic illustration and in a first direction of orientation shows an exemplary embodiment for the design embodiment of the closing element which is disposed on a shaft switchover unit;

FIG. 7b shows the closing element illustrated in FIG. 7a in a second direction of orientation;

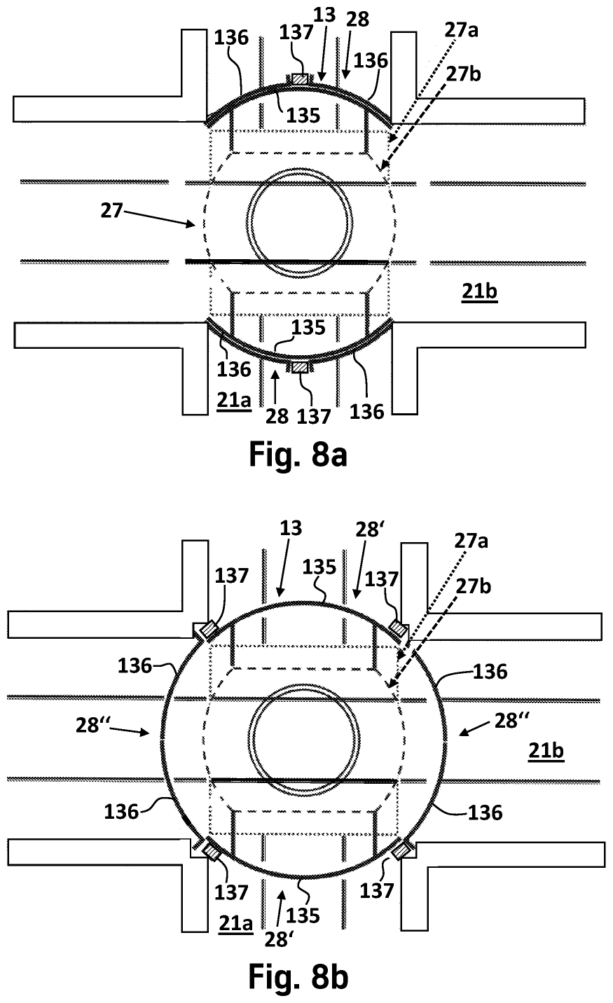

FIG. 8a in a simplified schematic illustration and in an opened state shows a further exemplary embodiment for the design embodiment of the closing element which is disposed on a shaft switchover unit; and

FIG. 8b shows the closing element illustrated in FIG. 8a in a closed state.

FIG. 1, FIG. 2, and FIG. 3 show in each case a simplified illustration of an exemplary embodiment of a fire protection device 10 according to the invention for an elevator system 20 having a rope guide. A car 22 and a counterweight 23 are displaced along guide rails 24 (illustrated with dashed lines) in an elevator shaft 21 of the elevator system 20, wherein the car 22 is connected to the counterweight 23 by way of a suspension rope 25 and a compensation rope 26, which may also be embodied as a compensation chain. The fire protection device 10 in the exemplary embodiments illustrated in FIG. 1, FIG. 2, and FIG. 3 comprises a control unit 11, a plurality of detectors 12, and a closing element 13. The detectors 12 are connected so as to communicate with the control unit 11. The closing element 13 is disposed in the elevator shaft 21 and is able to be transferred between an opened state and a closed state (illustrated with dotted lines).

The rope guide of the elevator system 20 requires a particular construction of the closing element 13 so that neither the suspension rope 25 nor the compensation rope 26 are damaged when transferring the closing element 13 from an opened state to a closed state. In order for damage to the rope guide to be avoided, the closing element 13 is divided into two closing element sectors 13a, 13b, wherein each of the two closing element sectors has in each case two closing element segments 134a, 134b. A first closing element sector 13a herein is assigned to a region of the elevator shaft 21 in which the car 22 is displaced, and a second closing element sector 13b is assigned to a region of the elevator shaft 21 in which the counterweight 23 is displaced.

The elevator shaft 21 in the exemplary embodiments illustrated in FIG. 1, FIG. 2, and FIG. 3 has two shaft portions 211a and 211b, wherein each of the two shaft portions has in each case one stop 212.

The closing element 13 is disposed in the elevator shaft 21 between the two mutually adjacent shaft portions 211a and 211b. In the closed state in which both closing element sectors 13a, 13b are closed, the closing element 13 mutually separates the two shaft portions 211a, 211b.

One detector 12 is in each case disposed in each of the two shaft portions 211a, 211b as well as in or on the car 22. The detectors 12 are specified for detecting a fire and/or smoke. The detectors 12 are in particular infrared detectors and/or smoke alarms. If one or a plurality of the detectors 12 detects/detect a fire and/or smoke, this detector 12 transmits, or these detectors 12 transmit, respectively, a corresponding signal to the control unit 11.

The signal transmitted to the control unit 11 contains an item of information pertaining to the location of the detector 12 that detects the fire and/or smoke. The signal thus contains an item of information pertaining to whether the detector 12 that detects the fire and/or smoke is disposed in the elevator shaft 21 or in, or on, respectively, the car 22.

In the case of the detector 12 that detects the fire and/or smoke being disposed in the elevator shaft 21, the control unit 11 receives the item of information pertaining to which of the two shaft portions 211a, 211b of the elevator shaft 21 the corresponding detector 12 is disposed in.

If the detector 12 disposed in, or on, respectively, the car 22 detects a fire and/or smoke, the control unit 11 thus receives a signal from this detector 12. The control unit 11 thereupon checks whether the car 22 is stopped at a stop 212 or whether the car 22 is displaced in a travel direction in the elevator shaft 21. If the car 22 stops at a stop 212, the control unit 11 thus prevents any onward travel of the car 22. The car 22 in this case pauses at the corresponding stop 212. If the control unit 11 establishes that the car 22 is being displaced in a travel direction in the elevator shaft 21, the car 22 is displaced to a predetermined, in particular the closest, stop 212 that is situated in the travel direction in which the car 22 is being displaced. When the car 22 reaches the stop 212, the car 22 is thus stopped at the stop 212 and prevented from any onward travel.

The control unit 11 as a function of the signal emitted by the detector 12, or the detectors 12, respectively, is specified for transferring the closing element 13 between an opened state and a closed state. If a detector 12 detects a fire and/or smoke in a shaft portion 211a, 211b and/or in the car 22, the control unit 11 thus actuates the closing element 13 so as to transfer the closing element 13 from the opened state to the closed state. By transferring the closing element 13 to the closed state, the shaft portion 211a, 211b in which a fire has to be assumed is separated from the adjacent shaft portion 211a, 211b.

The closing element 13 can be embodied in various ways. In the embodiment illustrated in FIG. 1, the closing element segments 134a, 134b of the first closing element sector 13a and of the second closing element sector 13b are pivotable swing doors. In the embodiment illustrated in FIG. 2, the closing element segments 134a, 134b of the first closing element sector 13a and of the second closing element sector 13b are configured as sliding doors. In the embodiment illustrated in FIG. 3, the closing element segments 134a of the first closing element sector 13a are configured as roller shutters, and the closing element segments 134b of the second closing element sector 13b are configured as folding shutters. The swing doors as well as the sliding doors, roller shutters and folding shutters herein are configured in such a manner that by closing the swing doors, sliding doors, roller shutters or folding shutters, respectively, the position of the suspension rope 25, or of the compensation rope 26, respectively, in the projection plane of the elevator shaft 21 is not substantially varied.

In the embodiment illustrated in FIG. 1, the pivotable swing doors of the first closing element sector 13a and of the second closing element sector 13b are disposed in such a manner that said closing element sectors in the closed state form a planar compact face which separates the first shaft portion 211a from the second shaft portion 211b. The first closing element sector 13a herein can be spaced apart from the second closing element sector 13b by a platform such as is illustrated in the embodiment illustrated in FIG. 2.

In a variant not illustrated of the embodiment illustrated in FIG. 1, the first closing element sector 13a and the second closing element sector 13b are disposed so as to be mutually offset in the vertical direction of the elevator shaft 21. The first closing element sector 13a and the second closing element sector 13b herein are spaced apart by a platform, wherein the platform at least partially extends in the vertical direction of the elevator shaft 21. In the closed state of the closing element 13 the two closing element sectors 13a, 13b, conjointly with the platform that is at least partially disposed in the vertical direction of the elevator shaft 21, form a stepped compact face which separates the first shaft portion 211a from the second shaft portion 211b.

In the embodiment illustrated in FIG. 2, a platform 213 is fixedly disposed in the elevator shaft 21. In the opened state of the closing element 13, one closing element segment 134a, 134b of the two-part sliding doors of the two closing element sectors 13a, 13b is in each case situated below the platform 213. A respective second closing element segment 134a, 134b of the two-part sliding door of the closing element sectors 13a, 13b in the opened state of the closing element 13 can either be situated outside the elevator shaft 21, for example in a foundation slab of the building, as is illustrated for the first closing element sector 13a, or be situated below a further platform 213 in the elevator shaft 21, as is illustrated for the second closing element sector 13b. In the closed state of the closing element 13, the sliding doors of the closing element sectors 13a, 13b, conjointly with the platform/the platforms 213, form a compact face. In particular, the closing element segments 134a, 134b of the sliding doors of the closing element sectors 13a, 13b by means of a mechanism can be repositioned such that the sliding doors of the closing element sectors 13a, 13b in the closed state of the closing element 13, conjointly with the platform/the platforms 213, form a planar compact face. In particular, the closing element segments 134a, 134b of the sliding doors of the closing element sectors 13a, 13b can be repositioned in such a manner that the sliding doors of the closing element sectors 13a, 13b in the closed state of the closing element 13, conjointly with the platform/the platforms 213, form a stepped compact face.

In an embodiment not illustrated, the closing element segments 134a, 134b of the first closing element sector 13a and of the second closing element sector 13b are of mutually different configurations. The first closing element sector 13a herein has pivotable swing doors, and the second closing element sector 13b has sliding doors, or vice versa.

The embodiment illustrated in FIG. 3 corresponds substantially to the embodiment illustrated in FIG. 2, wherein the closing element segments 134a of the first closing element sector 13a in FIG. 3 are configured as roller shutters, and the closing element segments 134b of the second closing element sector 13b are configured as folding shutters. In the opened state of the closing element 13, one closing element segment 134a of the two-part roller shutter of the closing element sector 13a and one closing element segment 134b of the two-part folding shutter of the closing element sector 13b is in each case situated below the platform 213. A respective second closing element segment 134a, 134b of the two-part roller shutter, or folding shutter, respectively, of the closing element sectors 13a, 13b in the opened state of the closing element 13 can either be situated outside the elevator shaft 21, for example in a foundation slab of the building, as is illustrated for the first closing element sector 13a, or be situated below a further platform 213 in the elevator shaft 21, as is illustrated for the second closing element sector 13b. In the closed state of the closing element 13, the roller shutters of the closing element sector 13a and the folding shutters of the closing element sector 13b, conjointly with the platform/the platforms 213, form a compact face. In particular, the closing element segments 134a, 134b of the closing element sectors 13a, 13b by means of a mechanism can be repositioned in such a manner that in the closed state of the closing element 13 the roller shutters of the closing element sector 13a and the folding shutters of the closing element sector 13b, conjointly with the platform/the platforms 213, form a planar compact face. In particular, the closing element segments 134a, 134b of the closing element sectors 13a, 13b can be repositioned in such a manner that in the closed state of the closing element 13 the roller shutters of the closing element sector 13a and the folding shutters of the closing element sector 13b, conjointly with the platform/the platforms 213, form a stepped compact face.

FIGS. 4a and 4b in a simplified schematic illustration and in a plan view show the closing element 13 in an elevator system 20 according to one of the embodiments illustrated in FIG. 1, FIG. 2, or FIG. 3. FIG. 4a herein shows the closing element 13 in an opened state, and FIG. 4b shows the closing element 13 in a closed state.

In the opened state of the closing element 13 as is illustrated in FIG. 4a, the pivotable swing doors, sliding doors, roller shutters or folding shutters, respectively, of the closing element sectors 13a, 13b are pivoted out, or pushed out, respectively, of the travel path of the car 22 and of the counterweight 23 such that the car 22 and the counterweight 23 can be displaced without impediment in the elevator shaft 21.

In the closed state of the closing element 13 as is illustrated in FIG. 4b, the pivotable swing doors, sliding doors, roller shutters or folding shutters, respectively, of the closing element sectors 13a, 13b are pivoted into, or pushed into, respectively, the travel path of the car 22 and of the counterweight 23 such that the first shaft portion in the elevator shaft is separated from the second shaft portion.

The closing element segments 134a, 134b of the closing element sectors 13a, 13b have in each case clearances 131 for the guide rails 24, wherein the clearances 131 for the guide rails 24 are adapted to the design embodiment of the guide rails 24. In this way, the spacing between the closing element segments 134a, 134b of the closing element sectors 13a, 13b in the closed state of the closing element 13 from the guide rails 24 is minimized.

The gap created on account of the spacing between the closed closing element segments 134a, 134b of the closing element sectors 13a, 13b and the guide rails 24 is closed by means of a sealing material 133, and a passage of smoke or a propagation of a fire from one shaft portion to another shaft portion is thus avoided.

Furthermore, the closing element segments 134a, 134b of the closing element sectors 13a, 13b have clearances 132 for the suspension rope 25, or the compensation rope 26, respectively. In the exemplary embodiment illustrated in FIG. 4b, a plurality of clearances 132 for the rope guide are disposed beside one another such that a comb pattern results. The clearances 132 are in each case disposed on an edge of the closing element segments 134a, 134b. A first closing element segment 134a′, 134b′ herein has the clearances 132 on that edge that faces the edge of a second closing element segment 134a″, 134b″ when the closing element 13 is situated in the closed state. Likewise, the second closing element segment 134a″, 134b″ has the clearances 132 on that edge that faces the edge of the first closing element segment 134a′, 134b′ when the closing element 13 is situated in the closed state. Clearances 132 for each pair of swing doors, sliding doors, roller shutters or folding shutters, respectively, of the two closing element sectors 13a, 13b herein are disposed in the closing element segments 134a, 134b in such a manner that the clearances 132 of the first closing element segment 134a′, 134b′ and the clearances of the second closing element segment 134a″, 134b″ lie opposite one another in the closed state of the closing element 13. The clearances 132 are thus disposed in such a manner that in the closed state of the closing element 13 a rope is in each case guided through a clearance 132 which is provided by a clearance 132 of the first closing element segment 134a′, 134b′ and a respective opposite clearance 132 of the second closing element segment 134a″, 134b″.

The regions of the closing element segments 134a, 134b of the swing doors, sliding doors, roller shutters or folding shutters, respectively, of the closing sectors 13a, 13b between the clearances 132 for the rope guide have in each case a tapered shape. On account of this tapered shape, the suspension rope 25 or the compensation rope 26, respectively, when transferring the closing element 13 to the closed state is guided into one of the clearances 132. By lining up a plurality of clearances 132 beside one another, damage to the suspension rope 25 or the compensation rope 26 is prevented by transferring the closing element 13 in the event of rope vibrations. On the other hand, it is avoided on account of the disposal of a plurality of clearances 132 beside one another that the suspension rope 25 or the compensation rope 26, respectively, by virtue of rope vibrations blocks the closing element 13 from completely closing.

In order to avoid a propagation of smoke and/or a fire through the gaps in the closing element 13 that are created by the clearances 132 for the rope guide, said gaps are filled by means of a deformable sealing material 133. The sealing material 133 is in particular a fire protection foam. Alternatively or additionally, the sealing material 133 is in the form of rubber lips or a brush seal which are in each case disposed on the mutually abutting edges of the closing element segments 134a, 134b of the swing doors, sliding doors, roller shutters or folding shutters, respectively, of the closing element sectors 13a, 13b.

FIG. 5 shows a simplified schematic illustration of a fire protection device 10 in an elevator system 20 having a plurality of elevator shafts in which a plurality of cars 22 are displaced individually, that is to say in a substantially mutually independent manner, by means of a linear motor drive. The elevator system 20 comprises vertically aligned elevator shafts in which the cars 22 are vertically displaced along the guide rails 24, as well as horizontally aligned elevator shafts in which the cars 22 are horizontally displaced along guide rails 24. The travel direction of a car 22 changes from the vertical to the horizontal or vice versa by means of shaft switchover units 27 which are configured as movably, in particular as rotatably, mounted rail elements. Furthermore, a car 22 can be switched from a first elevator shaft to a second elevator shaft while using shaft switchover units 27. In a further embodiment not illustrated, the elevator system 20 can also comprise diagonally aligned elevator shafts in which the cars 22 are obliquely displaced.

Closing elements 13 are disposed in the vertical elevator shafts as well as in the horizontal elevator shafts. As is illustrated in FIG. 5, the closing element 13 can be embodied in various ways. Some of the closing elements illustrated in FIG. 5 thus have only one door leaf, roller shutter or folding shutter, and some have two door leaves, roller shutters or folding shutters. Some of those closing elements 13 which in FIG. 5 have door leaves are configured as pivotable doors and some are configured as sliding doors.

The vertical elevator shafts as well as the horizontal elevator shafts can in each case have a plurality of shaft portions. One shaft portion is separated from the shaft portion adjacent thereto by transferring a closing element 13 to the closed state.

In the exemplary embodiment illustrated in FIG. 5 the closing elements 13 are disposed in such a manner that at least one closing element 13 has to be in each case transferred to the closed state in at least one vertical elevator shaft as well as in at least one horizontal elevator shaft in order for a shaft portion to be separated from all shaft portions that are adjacent to this shaft portion.

Detectors 12 are disposed on the cars 22 as well as in the elevator shafts in FIG. 5. If smoke and/or a fire is detected by a detector 12 in a car 22 or a shaft portion, this detector 12 thus transmits a signal to a control unit 11 of the elevator system 20. The signal herein contains an item of information pertaining to the shaft portion in which the detector 12 is disposed, when the detector 12 is disposed in an elevator shaft. If the detector 12 that detects smoke and/or a fire is disposed on a car 22, the signal thus contains an item of information pertaining to the car 22 on which the detector 12 is disposed.

If the detector 12 which transmits the signal to the control unit 11 is disposed on a car 22, and if the car 22 is displaced in a travel direction at the point in time at which the detector 12 transmits the signal to the control unit 11, the car 22 is thus displaced to a predetermined, in particular the closest, stop that lies in the travel direction of the car 22. As soon as the car 22 has reached the stop, the car 22 is prevented from any onward travel.

If the detector 12 that transmits the signal to the control unit 11 is disposed on a car 22, and if the car 22 at the point in time at which the detector 12 transmits the signal to the control unit 11 stops at a stop, the car 22 is thus prevented from any onward travel at this stop.

The shaft portion in which the detector 12 that has transmitted the signal to the control unit 11 is disposed, or the shaft portion in which the stop at which the car 22 is prevented from any onward travel is situated, respectively, is assigned to an exclusion region.

In the exemplary embodiment illustrated in FIG. 5, a detector 12 that is disposed in an elevator shaft detects a fire, whereupon the shaft portion in which this detector 12 is disposed is assigned to an exclusion region 30 (illustrated by guide rails 24 with a dotted pattern).

Before the exclusion region 30 is separated from the shaft portions adjacent to the exclusion region 30 by transferring the corresponding closing elements 13 to the closed state, it is checked whether a car 22 is in transit through the exclusion region 30. If a car 22 is in transit through the exclusion region 30, the car 22 is moved out of the exclusion region 30 without stopping.

Prior to transferring the closing elements 13 to the closed state, it is furthermore checked whether there is any risk of a closing element 13 to be closed colliding with a car 22. If a car 22 is being displaced in a travel direction in the direction of a closing element 13 that is to be transferred to the closed state, the car 22 is thus decelerated when the spacing between the car 22 and this closing element 13 corresponds to a value between a first limit value and a second limit value. In the case of a risk of the car 22 colliding with the closing element 13 being present, the car 22 transits through the exclusion region 30 without stopping before the exclusion region 30 is separated from the shaft portions that are adjacent thereto by transferring the closing elements 13. As soon as a risk of collision by transferring to the closed state is precluded, the closing elements 13 which need to be closed in order for the exclusion region 30 to be separated from the shaft portions that are adjacent thereto, a free transit clearance for the cars 22 through the exclusion region 30 is revoked, and the corresponding closing elements 13 are transferred to the closed state, as illustrated in FIG. 5.

Two variants arise when the exclusion region 30 has been separated from the shaft portions that are adjacent thereto. In a first variant, the cars 22 which are situated outside the exclusion region 30, are displaced to a predetermined stop, in particular a closest stop that is situated in the travel direction of the car 22, and at this stop prevented from any onward travel such that people situated in the car 22 can exit the car 22. In a second variant, the cars 22 which are situated outside the exclusion region 30 continue to be operated in normal operation outside the exclusion region 30.

FIGS. 6a and 6b show embodiments for a closing element 13 for a fire protection device 10 according to FIG. 5 in a plan view.

The closing element segment 134 of the closing element 13 in FIG. 6a is embodied in two parts. In a first design embodiment, the two-part closing element segment 134 is configured as pivotable swing doors which in the opened state of the closing element 13 are pivoted toward the shaft walls of the elevator shaft. In a second or further design embodiment, the two-part closing element segment 134 is configured as sliding doors, roller shutters or folding shutters which in the opened state of the closing element 13 are pushed out of the travel path of the car 22.

In the closed state of the closing element 13, the closing element segments 134 are pivoted into, or pushed into, respectively, the elevator shaft such that the two parts of the two-part closing element segment 134 form a compact plane.

The two-part closing element segment 134 in FIG. 6a is embodied in such a manner that the two parts of the closing element segment 134 in the closed state of the closing element 13 come together in a centric position of the guide rail 24. Both parts of the closing element segment 134 herein have in each case one clearance 131 for the guide rail 24, said clearance 131 being adapted to the shape of the guide rail 24.

By virtue of the closing element segment 134 being divided into two parts, as well as by virtue of the clearances 131 for the guide rail 24, a leakage of the closing element 13 results at the location where the two parts of the closing element segment 134 come together, in the closed state of the closing element 13. In order to counteract a propagation of smoke and/or a fire through this leakage of the closing element 13, the closing element 13 at these locations has a deformable sealing material 133. The sealing material 133 is in particular a fire protection foam by way of which the closing element 13 is sealed in the closed state. Alternatively or additionally, the sealing material 133 is in the form of rubber lips or a brush seal.

FIG. 6b shows a closing element 13 in which the closing element segment 134 is embodied in a single part, wherein the closing element segment 134 in a first design embodiment is embodied as a pivotable swing door, in a second design embodiment as a sliding door, and in a further design embodiment as a roller shutter or a folding shutter.

The closing element segment 134 of the embodiment of the closing element 13 illustrated in FIG. 6b in each of the mentioned design embodiments has one clearance 133 for the guide rail 24, wherein the clearance 133 is adapted to the shape of the guide rail 24 such that in the closed state of the closing element 13 a spacing between the closing element segment 134 from the guide rail 24 is minimal. A leakage of the closing element 13 that results from this spacing between the closing element segment 134 from the guide rail 24 is counteracted in that this spacing is filled by a deformable sealing material 133. The sealing material 133 is in particular a fire protection foam.

FIGS. 7a, 7b, 8a, and 8b show exemplary embodiments for a closing element 13 that is disposed on a shaft switchover unit 27. The shaft switchover unit comprises a stationary part 27a and a movable part 27b disposed thereon.

In the design embodiment shown in FIGS. 7a and 7b, the closing element 13 comprises fire-resistant static bulkheads 135, wherein in each case one static bulkhead 135 of circular configuration connected fixedly to the movable part 27b on both sides on the movable part 27b of the shaft switchover unit 27b.

The movable part 27b herein is configured as a rail element which is rotatably mounted on the stationary part 27a.

The static bulkheads 135 are disposed so as to be spaced apart on the rotatable part 27b in such a manner that a car can be driven without impediment between the static bulkheads 135.

The rotatable part 27b in FIG. 7a is aligned in a first direction of orientation such that a direction of travel for a car results in which the car is displaced in the first elevator shaft 21a. One static bulkhead 135 of the closing element 13 herein closes in each case one opening 28 to the second elevator shaft 21b.

The rotatable part 27b in FIG. 7b is aligned in a second direction of orientation such that a direction of travel for a car results in which the car is displaced in the second elevator shaft 21b. One static bulkhead 135 of the closing element 13 herein closes in each case one opening 28 to the first elevator shaft 21b.

The static bulkheads 135 that are disposed on the movable part 27b of the shaft switchover unit are thus, in normal operation, conjointly rotated with the movable part 27b.

If a fire or smoke is detected in the first/second elevator shaft, the movable part 27b is thus rotated such that the shaft switchover unit 27 by way of the static bulkheads 135 is separated from the first/second elevator shaft.

A safe travel path for a car is provided and the shaft switchover unit 27 is simultaneously protected in this way.

FIGS. 8a and 8b show an exemplary embodiment for a closing element 13 that is disposed on a shaft switchover unit 27, wherein the closing element 13 both has in each case one static bulkhead 135 on both sides of the movable part 27b, and also has in each case two movable bulkheads 136 on each of the two static bulkheads 135, said movable bulkheads 136 being able to be set in motion by way of drives 137 so as to transfer the closing element 13 from an opened state to a closed state.

FIG. 8a shows the closing element 13 in an opened state. In normal operation of the elevator system, the two movable bulkheads 136 that are disposed on a static bulkhead 135 are disposed so as to be parallel to the static bulkhead 135, wherein the movable bulkheads 136 do not form any protrusion in relation to the static bulkhead 135.

As a function of a signal emitted by the detector of the fire protection device, the control unit transfers the closing element 13 between the opened state and closed state in that the control unit actuates the respective drive 137 of that movable bulkhead 136 that is to be transferred.

Each of the movable bulkheads 136 is individually actuatable by way of the control unit.

If the orientation of the movable part 27b, as shown in FIGS. 8a, 8b, corresponds to the direction of the second elevator shaft 27b, the static bulkheads 135 thus close the openings 28′ to the contiguous first elevator shaft 27a.

If smoke and/or a fire is now detected by the detector, the control unit thus actuates one or a plurality of drives 137 such that an opening 28″ or both openings 28″ to the second elevator shaft that are contiguous to the shaft switchover unit 27 are partially or completely closed by the movable bulkheads 136.

FIG. 8b shows the closing element 13 in the closed state in which all movable bulkheads 136 are completely closed. In this state, the shaft switchover unit 27 is completely insulated in relation to the remaining elevator system. In the event of fire, the shaft switchover unit 27 would thus be protected against damage by the fire.

### LIST OF REFERENCE SIGNS

10 Fire protection device

11 Control unit

12 Detector

13 Closing element
13a First closing element sector
13b Second closing element sector

131 Clearance for guide rail

132 Clearance for rope guide

133 Sealing material

134 Closing element segment
134a Closing element segment of the first closing element sector
   134a′ First closing element segment of the first closing element sector
   134a″ Second closing element segment of the first closing element sector
134b Closing element segment of the second closing element sector
   134b′ First closing element segment of the second closing element sector
   134b″ Second closing element segment of the second closing element sector

135 Static bulkhead

136 Movable bulkhead

137 Drive

20 Elevator system

21 Elevator shaft
21a First elevator shaft
21b Second elevator shaft

211 Shaft portion
211a First shaft portion
211b Second shaft portion

212 Stop

213 Platform

22 Car

23 Counterweight

24 Guide rail

25 Suspension rope

26 Compensation rope/chain

27 Shaft switchover unit
27a Stationary part
27b Movable part

28 Opening

30 Exclusion region

1.-25. (canceled)

26. An elevator system comprising:
an elevator shaft;
at least one guide rail disposed in said elevator shaft;
a car displaceable on said guide rail within said elevator shaft; and
a fire protection device disposed within said elevator shaft having:
a closing element disposed in said elevator shaft that is movable between an opened state and a closed state, such that in said closed state, said closing element mutually separates the elevator shaft into a first shaft portion and a second shaft portion.

27. The elevator system of claim 26, wherein said fire protection device further comprises:
at least one detector configured to detect the presence of at least one of smoke or fire in one of said first or second shaft portions and emit a signal in response thereto,
a control unit in communication with said detector that is configured to receive the signal from said detector, and move said closing element between the opened state and the closed state as a function of the presence or absence of the signal emitted by said detector.

28. The elevator system of claim 27, wherein one of said at least one detector is disposed in at least one of the first or second shaft portions, and/or another of said at least one detector is disposed at least one of on, or in, said car.

29. The elevator system of claim 26, wherein said closing element has at least one clearance defined therein that is configured to permit at least one shaft element extending in a direction perpendicular to the closing element to pass therethrough.

30. The elevator system of claim 29, wherein said closing element comprises a plurality of closing element segments, wherein said clearance is defined in at least one edge of one of said closing element segments.

31. The elevator system of claim 26, wherein said elevator shaft includes:
a first elevator shaft,
a second elevator shaft, and
a shaft switchover unit configured to permit said car to travel between the first elevator shaft and the second elevator shaft, wherein each of said first elevator shaft and said second elevator shaft have at least two shaft portions,
wherein said closing element includes at least a first of said closing element disposed between two mutually adjacent shaft portions of at least one of said first elevator shaft or said second elevator shaft, and wherein said at least first closing element in the closed state mutually separates the two mutually adjacent shaft portions of said at least one of said first elevator shaft or said second elevator shaft.

32. The elevator system of claim 26, wherein said elevator shaft includes:
a first elevator shaft,
a second elevator shaft, and
a shaft switchover unit configured to permit said car to travel between the first elevator shaft and the second elevator shaft, said shaft switchover unit having:
a stationary part fixedly disposed on a shaft wall in a crossover region of said first elevator shaft and said second elevator shaft, and
a movable part movably coupled to the stationary part,
wherein a travel direction of said car is defined by an orientation of said movable part, and wherein said closing element is disposed on said shaft switchover unit.

33. The elevator system of claim 32, wherein said closing element is disposed on said movable part and comprises at least one static bulkhead disposed on the movable part such that said closing element at all times closes at least one opening to either said first elevator shaft or said second elevator shaft, said opening being situated in a direction that is not parallel to the travel direction of the car.

34. The elevator system of claim 33, wherein said closing element comprises at least one movable bulkhead movably disposed on the at least one static bulkhead, and wherein said control unit is configured to transfer said at least one movable bulkhead between the opened state and the closed state as a function of a signal emitted by said detector.

35. The elevator system of claim 34, wherein in a normal operation mode, said at least one movable bulkhead is entrained by the static bulkhead on which said movable bulkhead is disposed.

36. A method of operating an elevator system having an elevator shaft defining at least a first shaft portion and a second shaft portion, at least one guide rail disposed in the elevator shaft, a car displaceable on the guide rail, and a fire protection device disposed within the elevator shaft that includes a closing element that is movable between an opened state and a closed state, such that in said closed state, said closing element mutually separates the first shaft portion and the second shaft portion, the method comprising:
detecting at least one of smoke or a fire by a detector; and
moving the closing element disposed in the elevator shaft from the opened state to the closed state so as to substantially prevent the at least one of smoke or fire from moving from one of the first or second shaft portions to the other of the first or second shaft portions.

37. The method of claim 36, further comprising:
after said detecting step, transmitting, from the detector to a control unit, a signal containing information pertaining to a first shaft portion in which the detector is located.

38. The method of claim 37, wherein the detector is affixed to the elevator car, the method further comprising:
concurrently with said transmitting step, one of moving the car currently in transit to a predetermined stop located in a current travel direction of the car, or
preventing the car from any further travel from a stop at which the car is currently stopped.

39. The method of claim 38, further comprising:
assigning the first shaft portion to an exclusion region, wherein
the predetermined stop and/or
the stop at which the car is currently stopped, is located in the first shaft portion.

40. The method of claim 39, further comprising:
detecting whether at least one of the car or a counterweight is in transit through the exclusion region; and
displacing the respective car and/or the counterweight out of the exclusion region without stopping, upon confirmation that at least one of the car or counterweight is in transit through the exclusion region.

41. The method of claim 39, further comprising:
detecting whether there is a risk of at least one of the car or the counterweight colliding with the closing element as a result of a movement of the closing element to the closed state.

42. The method of claim 41, further comprising:
displacing at least one of the respective car or the counterweight in a travel direction towards the closing element to be transferred to the closed state; and
either,
moving the respective car and/or the counterweight through the exclusion region without stopping, upon confirmation of a risk of collision, or
decelerating the respective car and/or counterweight upon confirmation that a distance between the respective car and/or counterweight and the closing element is between a first limit value and a second limit value.

43. The method of claim 42, further comprising:
displacing the car that has been decelerated to a stop located outside the exclusion region.

44. The method of claim 40, further comprising:
by the control unit, revoking a free transit clearance for at least one of the car and/or the counterweight through the first shaft portion assigned to the exclusion region; and
moving the closing element to the closed state, as soon as at least one of:
the respective car and/or counterweight has been displaced out of the exclusion region, or
any risk of the car and/or counterweight colliding with the closing element as a result of the transfer of the closing element to the closed state is precluded.

45. The method of claim 36, further comprising:
moving the closing element to the closed state so as to separate the first shaft portion from the second shaft portion.

46. The method of claim 40, further comprising at least one of:
generating a vacuum in the exclusion region with the closing element in the closed state; or
activating a pressurized ventilation in a second shaft portion contiguous to the exclusion region.
